(19) United States
(12) Patent Application Publication
(10) Pub. No.: US 2016/0024307 A1
(43) Pub. Date: Jan. 28, 2016

(54) USE OF POLYCARBOXYLATE ETHERS IN COMBINATION WITH OTHER ADDITIVES FOR MILLING CEMENT

(71) Applicant: SIKA TECHNOLOGY AG, Baar (CH)

(72) Inventors: Dieter HONERT, Dielheim (DE); Thomas HELLER, Meckesheim (DE); Thomas MÜLLER, Heidelberg (DE)

(21) Appl. No.: 14/773,446

(22) PCT Filed: Mar. 6, 2014
(86) PCT No.: PCT/EP2014/054354

§ 371 Date: Sep. 8, 2015

(30) Foreign Application Priority Data
Mar. 13, 2013 (EP) 13159010.1

(51) Int. Cl. C08L 97/00; C08K 5/17; C08K 5/42; C08L 67/00; C08K 5/053

(52) U.S. Cl. CPC C08L 97/005; C08L 67/00; C08K 5/053; C08K 5/42; C08K 5/17; C08L 2555/82

(57) ABSTRACT

Use of an aqueous composition containing at least one polycarboxylate ether as cement grinding aid, wherein the aqueous composition contains one or more additives, or the aqueous composition is used in combination with one or more additives, and wherein the additive is selected from 1,3-propanediol, a carboxylic acid, a sulfonated amino alcohol, boric acid, a salt of boric acid, a salt of phosphoric acid, sorbitol, a saccharide, a gluconate, iron sulfate, tin sulfate, an antimony salt, an alkali salt, an alkaline earth salt, lignin sulfonate, glycerol, melamine, melamine sulfonate and mixtures thereof.

### TECHNICAL FIELD

The invention relates to the use of cement grinding aids, to the cement grinding aid, and to a method for producing cement using the cement grinding aid.

### PRIOR ART

The production of cement is a very complex process. As is known, cement is very sensitive to water, regardless of whether it is in the liquid or gaseous state, since cement sets hydraulically, that is to say it cures under the influence of water, within a short time to a very stable solid. A central step in the production of cement is the milling of the clinker. Since clinker is very hard, the crushing is very laborious. For the properties of the cement, it is important that it is in the form of a fine powder. The fineness of the cement is therefore an important quality characteristic. In order to facilitate the crushing in powder form, so-called cement grinding aids are used. As a result, the milling times and energy costs are reduced considerably. Such cement grinding aids are usually selected from the class comprising glycols such as alkylene glycols, amines or amino alcohols.

Thus, for example, U.S. Pat. No. 5,084,103 describes trialkanolamines such as triisopropanolamine (TIPA) or N,N-bis(2-hydroxyethyl)-N-(2-hydroxypropyl)amine and tris(2-hydroxybutyl)amine as grinding aids for clinker.

Moreover, from WO 97/10308 or EP 0100947 A1, water-soluble polycarboxylates as grinding aids are known for the production of aqueous suspensions of minerals such as chalk or pigments, particularly for use in paper manufacturing. US 2002/0091177 A1 describes the use of ethylenically unsaturated monomers as grinding aid for the production of aqueous suspensions of milled mineral fillers. Moreover, this document describes that a cement that is mixed with such an aqueous suspension leads to improved early strength. However, in none of these documents is a cement grinding aid disclosed.

The use of so-called concrete liquifiers has been known for a long time. For example, from EP 1138697 B1 or EP 1061089 B1, it is known that (meth)acrylate polymers with ester side chains and optionally with amide side chains are suitable as concrete liquifiers. In the process, this concrete liquifier is added to the cement as an additive or it is added to the cement before milling, and it leads to a high degree of liquefaction or a reduction of the water requirement of the concrete or mortar produced therefrom.

In WO 2005/123621, the use of special polycarboxylate ethers is described, including in combination with glycols, organic amines and ammonium salts of organic amines with carboxylic acids, as a cement grinding aid. It was observed that by combining the special polycarboxylate ethers with glycols, organic amines or ammonium salts of organic amines with carboxylic acids, the disadvantages of the known grinding aids can be eliminated or greatly reduced, without loss of the advantageous effects of polycarboxylate ethers.

To achieve the desired effect, very large quantities of quite expensive glycols, organic amines and ammonium salts of organic amines with carboxylic acids can often be required here, so that an optimization need still exists here.

U.S. Pat. No. 6,641,661 B1 relates to a method for improving the early strength of cement, comprising the addition of a water reducing agent comprising a polyalkylene polymer, a sugar, an alkali or alkaline earth metal chloride and an amine to the cement during the milling.

US 2004/149172 A1 relates to a cement additive which comprises a liquid carrier, an alkali or alkaline earth salt as solid particle and another component which can be an amine, alkanolamine, modified polyethyleneamine, glycol, a carbohydrate or a surfactant. The liquid carrier can be a polycarboxylate.

WO 2011/033124 A1 relates to the use of an additive comprising a lignin sulfonate for reducing the floating of rust on mineral binders. The additive can contain a polycarboxylate comb polymer.

EP 1728771 A2 describes a grinding aid for particles such as cement, which comprises a polyol derived from biomass and which can contain a second grinding aid which can be selected from triethanolamine, acetic acid, carbohydrates, polycarboxylate ethers, chlorides, nitrites or nitrates, among other compounds.

### PRESENTATION OF THE INVENTION

The problem of the invention therefore relates to providing a grinding aid by means of which the efficiency of the milling of cement can be optimized. This was achieved surprisingly by combining a polycarboxylate ether with special additives.

The present invention therefore relates to the use of an aqueous composition containing at least one polycarboxylate ether as cement grinding aid, wherein the aqueous composition contains one or more additives or the aqueous composition is used in combination with one or more additives, and wherein the additive is selected from 1,3-propanediol, a carboxylic acid, a sulfonated amino alcohol, boric acid, a salt of boric acid, a salt of phosphoric acid, sorbitol, a saccharide, a gluconate, iron sulfate, tin sulfate, an antimony salt, an alkali salt, an alkaline earth salt, a lignin sulfonate, glycerol, melamine, melamine sulfonate and mixtures thereof.

It is known that polycarboxylate ethers that can be added as improver for cement milling are not very good milling aids. It has been shown that the polycarboxylate ethers in a mixture with the special additives according to the present invention surprisingly have similar milling properties to those of the pure substances.

Polycarboxylate ethers, depending on the need, have different effects on the processability of fresh concrete or fresh mortar. Thus, so-called precast polymers result in a high initial liquefaction and high slump loss. On the other hand, so-called slump keeper polymers result in a good initial liquefaction and little back stiffening. It was observed that it is possible to produce mixtures of the polycarboxylate ethers with the special additives according to the invention that have the same tendencies with regard to the processability of fresh concrete or fresh mortar as pure polycarboxylate ethers. In addition, it was surprising that mixtures of polycarboxylate ethers with the special additives according to the invention can be produced that have barely any influence on the processability such as, for example, on the slump.

Thus, the mixtures of PCE and additive according to the invention increase the millability. In addition, using these cement additives, the processability of the fresh concrete produced from this cement can be adjusted. Moreover, using such mixtures, it is possible to increase the milling efficiency of the cement without influencing the processability of the concrete produced therefrom. Whether and how much the processability is influenced depends on the chemical structure of the PCE used, among other factors.

By adding the cement additive according to the invention, the efficiency of the milling of cement, of hydraulic, latent hydraulic, nonhydraulic and/or pozzolanic substances can be increased.

### WAY OF IMPLEMENTING THE INVENTION

The present invention thus relates to cement grinding aids consisting of an aqueous composition containing a polycarboxylate ether in combination with one or more special additives and to their use as cement grinding aids.

The aqueous composition thus contains a polycarboxylate ether (PCE). Any of the common polycarboxylate ethers can be used. The polycarboxylate ether is, in particular, a comb polymer which has a polycarboxylate backbone and polyether side chains, wherein the polyether side chains are bound preferably via ester, ether and/or amide groups to the polycarboxylate backbone. To the extent that reference is made to the polycarboxylate ether in the following specifications, the indication is always considered to refer also to the above-mentioned preferred forms and in particular to the comb polymer KP defined below as preferred or particularly preferred embodiment forms correspondingly.

The polycarboxylate ether is preferably a comb polymer KP which comprises or consists of the following partial structural units:

a) a mole fractions of a partial structural unit S1 of formula (I)

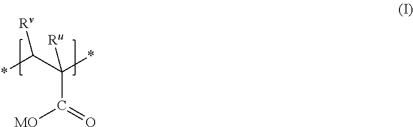

b) b mole fractions of a partial structural unit S2 of formula (II)

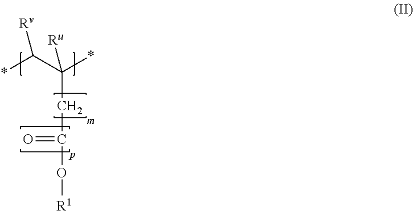

c) c mole fractions of a partial structural unit S3 of formula (III)

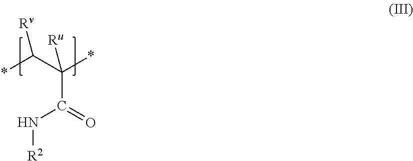

d) d mole fractions of a partial structural unit S4 of formula (IV)

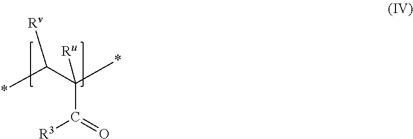

wherein

M independently of one another represents H⁺, an alkali metal ion, alkaline earth metal ion, a bi- or trivalent metal ion, an ammonium ion or an organic ammonium group,

each R^{u} independently of the others stands for hydrogen or a methyl group,

each R^{v} independently of the others stands for hydrogen or COOM,

m=0, 1 or 2,

p=0 or 1,

R¹ and R² independently of one another stand for a C₁ to C₂₀ alkyl group, cycloalkyl group, alkylaryl group or for -[AO]ₙ—R⁴,
wherein A=C₂ to C₄ alkylene, R⁴ stands for H, a C₁ to C₂₀ alkyl group, cyclohexyl group or alkylaryl group,
and n=2-250,

R³ independently of one another stands for NH₂, —NR⁵R⁶, —OR⁷NR⁸R⁹,
wherein R⁵ and R⁶ independently of one another stand for
   a C₁ to C₂₀ alkyl group, cycloalkyl group,
   alkylaryl group or aryl group,
   or for a hydroxyalkyl group or for an
   acetoxyethyl (CH₃—CO—O—CH₂—CH₂—) or a
   hydroxyisopropyl (HO—CH(CH₃)—CH₂—) or an
   acetoxyisopropyl (CH₃—CO—O—CH(CH₃)—CH₂—) group;
or R⁵ and R⁶ together form a ring of which the nitrogen is a part, in order to build a morpholine or imidazoline ring;
R⁷ is a C₂-C₄ alkylene group,
R⁸ and R⁹ each independently of one another represent a C₁ to C₂₀ alkyl group, cycloalkyl group, alkylaryl group, aryl group, or a hydroxyalkyl group,

and wherein a, b, c and d represent mole fractions of the respective partial structural units S1, S2, S3 and S4, where

a/b/c/d=(0.1-0.9)/(0.1-0.9)/(0-0.8)/(0-0.8),

in particular a/b/c/d=(0.3-0.9(/(0.1-0.7)/(0-0.6)/(0-0.4),

preferably a/b/c/d=(0.5-0.8)/(0.2-0.4)/(0.001-0.005)/0

and with the proviso that a+b+c+d=1.

The sequence of the partial structural units S1, S2, S3 and S4 can be alternating, block like or random. In principle, it is also possible that other structural units are present in addition to the partial structural units S1, S2, S3 and S4.

Preferably, the partial structural units S1, S2, S3 and S4 together account for a proportion by weight of at least 50% by weight, in particular at least 90% by weight, most particularly preferably at least 95% by weight, of the total weight of the comb polymer KP.

According to an additional advantageous embodiment, the comb polymer KP is, in particular, free of aromatic compounds and/or aromatic structural units.

A weight average molecular weight (M_{w}) of the polycarboxylate ether, preferably of the comb polymer KP, is, in particular, 5000-150,000 g/mol, especially 10,000-100,000 g/mol. The weight average molecular weight (M_{w}) here and below is determined by gel permeation chromatography (GPC), wherein polyethylene glycol (PEG) is used as standard.

The preparation of the comb polymers in itself is known to the person skilled in the art and it can occur, for example, by radical polymerization of the corresponding monomers of formula (Iₘ), (IIₘ), (IIIₘ) or (IVₘ), which leads to a comb polymer KP with the partial structural units S1, S2, S3 and S4. Here, the residues R^{u}, R^{v}, R¹, R², R³, M, m and p are defined as described above.

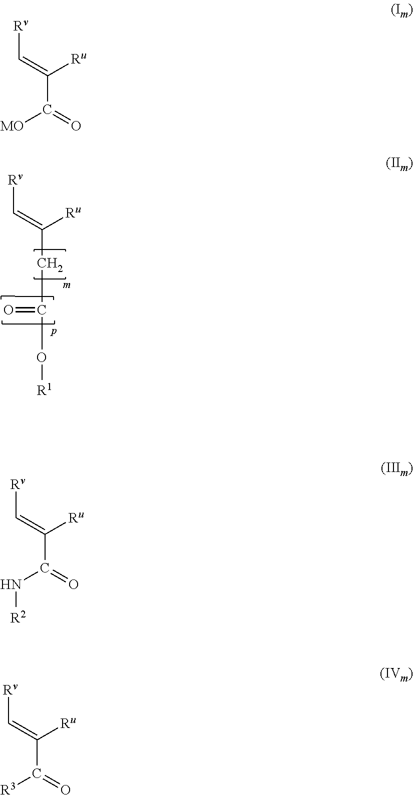

Also possible is the preparation of the comb polymers KP by a polymer-analogous reaction of a polycarboxylic acid of formula (V).

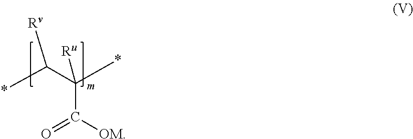

In the polymer-analogous reaction, the polycarboxylic acid of formula (V) is esterified or amidated with the corresponding alcohols or amines (for example, HO—R¹, H₂N—R², H—R³), and then, if needed, it is neutralized or partially neutralized (depending on the type of the residue M, for example, with metal hydroxides or ammonia). Details on the polymer-analogous reaction are disclosed, for example, in EP 1 138 697 B1 on page 7, line 20 to page 8, line 50 as well as in its examples, or in EP 1 061 089 B1 on page 4, line 54 to page 5, line 38 as well as in its examples. In a variation thereof, as described in EP 1 348 729 A1 on page 3 to page 5 as well as in its examples, the comb polymer can be produced in the solid state. The disclosure of these mentioned patent specifications is thus included herewith, in particular by reference. The production by polymer-analogous reaction is preferred.

Corresponding comb polymers are marketed by Sika Schweiz AG under the trade name

### ViscoCrete®.

Preferred are comb polymers KP, wherein R¹ or R² independently of one another stands for -[AO]ₙ—R⁴, wherein A=C₂ to C₄ alkylene, R⁴ stands for H, a C₁ to C₂₀ alkyl group, cycloalkyl group or alkylaryl group, and n=2-250.

Most particularly suitable are comb polymers KP wherein

a) the residue R^{v} stands for hydrogen,

b) the residue R^{u} stands for hydrogen or for a methyl group or for a mixture of a methyl group and hydrogen. In the last case, a molar ratio of the methyl group to the hydrogen is in particular 25:75-75:25, in particular 40:60-60:40.

c) m=0,

d) p=1,

e) R¹, in each case independently of one another, stands for -[AO]ₙ—R⁴, where n=20-70 and A=C₂ alkylene,

f) R², in each case independently of one another, stands for -[AO]ₙ—R⁴, wherein A stands in particular for a mixture of C₂ and C₃ alkylene, R₄ advantageously represents a methyl group and, in particular, n=20-70. A weight average molecular weight of the group -[AO]ₙ—R⁴ is here advantageously 1000-3000 g/mol. A molar ratio of the C₂ alkylene units to the C₃ alkylene units is, in particular, 25:75-75:25, in particular 40:60-60:40.

g) R⁴ represents a methyl group and/or

h) a/b/c/d=(0.5-0.8)/(0.2-0.4)/(0.001-0.005)/0.

The preparation of the aqueous composition occurs by adding water during the production of the polycarboxylate ether or by subsequently mixing polycarboxylate ether with water.

The proportion of the polycarboxylate ether in the aqueous composition can vary in broad ranges. Typically, the proportion of the polycarboxylate ether is, for example, 5 to 90% by weight, in particular 10 to 50% by weight, relative to the weight of the aqueous composition.

Depending on the type of the polycarboxylate ether, a dispersion or a solution forms. A solution is preferred.

As described above, WO 2005/123621 discloses the use of aqueous compositions containing a polycarboxylate ether in combination with at least one additional grinding aid selected from the group consisting of glycols, organic amines and ammonium salts of organic amines with carboxylic acids.

Examples of suitable glycols, organic amines and ammonium salts of organic amines with carboxylic acids are monoethylene glycol, diethylene glycol, triethylene glycol, tetraethylene glycol, pentaethylene glycol, polyethylene glycol, in particular with 6 or more ethylene units, for example, PEG 200, neopentyl glycol, hexylene glycol, propylene glycol, dipropylene glycol, polypropylene glycol, monoethanolamine, diethanolamine, triethanolamine (TEA), diethanol isopropanolamine, ethanol diisopropanolamine, isopropanolamine, diisopropanolamine, triisopropanolamine (TIPA), N-methyl diisopropanolamine, N-methyl diethanolamine, tetrahydroxyethylethylenediamine (THEED) and tetrahydroxyisopropylethylenediamine (THIPD) and salts of these amines.

According to the present invention, the aqueous composition containing a polycarboxylate ether together with one or more special additives is used as cement grinding aid, wherein the one or more additives are contained in the aqueous composition and used as separate component together with the aqueous composition.

Preferred is an aqueous composition which contains at least one polycarboxylate ether and the one or more additives.

In principle it is also possible, although less preferable, to use an aqueous composition containing at least one polycarboxylate ether in combination with one or more additives as separate component, that is to say that, in this case, the aqueous composition and the one or more additives are present separately and added separately from one another to the clinker or cement during or preferably before the milling of the clinker or cement.

The additive is selected from 1,3-propanediol, a carboxylic acid, a sulfonated amino alcohol, boric acid, a salt of boric acid, a salt of phosphoric acid, sorbitol, a saccharide, a gluconate, iron sulfate, tin sulfate, an antimony salt, an alkali salt, an alkaline earth salt, lignin sulfonate, glycerol, melamine, melamine sulfonate and mixtures of two or more of these additives.

The carboxylic acid is preferably selected from formic acid, acetic acid, propionic acid, lactic acid and citric acid.

The term lignin sulfonate comprises the substances sodium lignin sulfonate (CAS No. 8061-51-6), magnesium lignin sulfonate (CAS No. 8061-54-9), calcium lignin sulfonate (CAS No. 8061-52-7). The cation plays no role in the efficacy in the present invention.

The alkali or alkaline earth salt is preferably selected from alkali or alkaline earth halide, alkali or alkaline earth nitrate, alkali or alkaline earth nitrite, and alkali or alkaline earth thiocyanate. Examples of alkali and alkaline earth halides are alkali and alkaline earth chlorides, alkali and alkaline earth fluorides, alkali and alkaline earth bromides, and alkali and alkaline earth iodides. Examples of suitable alkali and alkaline earth metals for these salts are Li, Na, K, Mg and Ca. Concrete examples are calcium chloride, sodium chloride, sodium thiocyanate and sodium carbonate.

Boric acid and its salts, salts of phosphoric acid, saccharides, sorbitol and gluconates are also known as retarders. The saccharides or carbohydrates can be polysaccharides and oligosaccharides or sugar, for example. Sodium gluconate is an example of a gluconate.

Iron sulfate, tin sulfate and antimony salt are also known as chromate(VI)-reducing substances in cements.

In addition to the above-described additives, the aqueous composition can contain at least one additional grinding aid, or the aqueous composition and the additive(s) can be used in combination with at least one additional grinding aid, wherein the other grinding aid is selected from the group consisting of glycols, polyols, organic amines and ammonium salts of organic amines with carboxylic acids.

Concrete examples of suitable glycols, organic amines and ammonium salts of organic amines with carboxylic acids have been mentioned above. As glycols, alkylene glycols are particularly suitable here, particularly those of formula OH—(CH₂—CH₂O)ₙ—CH₂CH₂—OH where n=0-20, in particular 0, 1, 2 or 3. Alkanolamines are particularly preferred as organic amines, above all trialkanolamines, preferably triisopropanolamine (TIPA) or triethanolamine (TEA).

In this variant as well, in which in addition at least one other grinding aid is used, the aqueous composition preferably contains, in addition to the polycarboxylate ether, the additive(s) and at least one grinding aid selected from the group consisting of glycols, organic amines and ammonium salts of organic amines with carboxylic acids.

However, it is also possible, although not preferable, that the additive(s) and the at least one grinding aid individually or together are present as separate component, that the aqueous composition contains the additive(s) and the at least one grinding aid is present as separate component or that the aqueous composition contains the at least one milling agent and the additive(s) is/are present as separate component. In these cases, during or preferably before the milling of the clinker or of the cement, the aqueous composition and the one or two other components are added separately from one another to the clinker or to the cement.

In a particularly preferred embodiment, the other grinding aid is an alkanolamine and the additive is a carboxylic acid or a retarder selected from boric acid, a salt of boric acid, a salt of phosphoric acid, sorbitol, a saccharide and a gluconate, wherein the carboxylic acid or the retarder is contained in the aqueous composition or it is used in combination with the aqueous composition, wherein the carboxylic acid or the retarder is contained preferably together with the alkanolamine in the aqueous composition.

The aqueous composition can contain other constituents. Examples thereof are organic solvents or additives such as those commonly used in the concrete technology, in particular surfactants, heat and light stabilizers, dyes, defoamers, accelerators, corrosion inhibitors, air entraining agents.

The aqueous composition is added in combination with the additive(s) and optionally with the at least one other grinding aid to the clinker or to the cement before the milling and is subsequently milled to form the cement or finer cement, wherein the additive(s) and/or the optional other grinding aid is/are contained in the aqueous composition or added separately. In principle, the addition of the aqueous composition can also occur in combination with the additive(s) and optionally with the at least one additional grinding aid during the milling process. However, the addition before the milling is preferable.

The addition can occur before, during or after the addition of gypsum and optionally other added milling substances such as chalk, blast furnace slag, fly ashes or pozzolans, for example. The aqueous composition can also be used for milling cement or for producing mixed cements. For the latter, individual cements, which are each produced separately by milling with the aqueous composition, are mixed, or a mixture of multiple cement clinkers is milled with the aqueous composition in order to obtain a mixed cement.

The use according to the invention of the aqueous composition according to the invention in combination with the one or more additives is very suitable as cement grinding aid. It is thereby possible to produce cements of the greatest variety from clinker or to mill such cements, for example, such cements classified according to DIN EN 197-1 such as CEM I (Portland cement), CEM II, CEM III (blast furnace cement), CEM IV and CEM V. CEM II is preferable.

The aqueous composition is metered into the clinker or cement preferably so that the proportion of the polycarboxylate ether is 0.001-1.5% by weight, in particular 0.005 to 0.2% by weight, preferably 0.005 to 0.1% by weight, relative to the clinker to be milled or to the cement to be milled.

It has been shown, among other findings, that already significantly smaller concentrations of the polymer A relative to the cement can be used effectively as cement grinding aid if it is used in combination with the above-described additive. Typically, according to the prior art, approximately 0.2 to 1.5% by weight polycarboxylate ether were added as liquefier to the cement.

The milling process usually takes place in a cement mill. However, in principle, other mills as are known in the cement industry, for example, can also be used. The cement has a different fineness depending on the milling time. The fineness of cement is usually indicated according to Blaine in cm²/g. On the other hand, the particle size distribution is also of practical relevance for the fineness. Such particle size analyses are usually conducted by laser granulometry or air jet sieves.

By the use according to the invention of the aqueous composition in combination with the one or more additives, the milling time for achieving the desired fineness, for example, the Blaine fineness, can be reduced. Due to the resulting reduced energy costs, the use of this cement grinding aid is economically very advantageous.

Moreover, it has been found surprisingly that, by combining polycarboxylate ethers with the described additives, a cement milling agent is obtained which combines the advantages of the polycarboxylate ether and of the additives and which reduces or even eliminates their disadvantages. The cement thus produced can also have a greatly reduced water requirement and it can have excellent early strengths, curing properties and a high slump.

The cement thus milled, like any other milled cement, has a broad range of use, for example, in concrete, mortars, casting compounds, injections or plasters.

If larger quantities of polycarboxylate ether are added to the cement during or before the milling of the clinker, one can observe the known liquefaction properties of polycarboxylate ethers after it has been mixed with water. Thus, in a preferred embodiment of the invention, it is possible, already during or before the milling, to add to the clinker or cement as much polycarboxylate ether in the form of an aqueous composition in combination with the one or more additives as are usually added to the cement as additive, in order to allow a desired liquefaction in contact with the water. Typically, this quantity is 0.2 to 1.5% by weight of polycarboxylate ether relative to the cement. In this way, according to this embodiment, an additional admixing of a liquefier is no longer necessary and the user of the cement can thus omit one work step. Such a cement represents a ready-to-use product which can be produced in large quantities.

The following are examples for further explaining the invention, which, however, are in no way intended to limit the invention.

### EXAMPLES

The milling fineness was determined using the air permeability method (Blaine) according to EN 196 with the automatic Blaine apparatus of the Wasag Chemie company. The slump was determined according to N 13395 using a standard mortar (water/cement=0.5 based on the weight).

As polycarboxylate ethers, commercial polycarboxylate ethers (PCE) were used, as marketed, for example, as products for concrete additives by Sika Schweiz AG. They are comb polymers KP as defined above, wherein PCE 1 is a comb polymer KP based on a poly(acrylate) main chain (R^{v}═R^{u}═H) and PCE 2 is a comb polymer KP based on a poly(methacrylate) main chain (R^{v}═H and R^{u}=Me). In the case of PCE 1 and PCE 2, in each case m=0, p=1 and R¹=-[AO]ₙ—R⁴ where A=C₂ alkylene, n=45 and R⁴=CH₃.

A. Milling of a Cement with a Combination of PCE and Additive

The cement was milled in a closed laboratory ball mill (so-called batch mill). The additive was added to the mill before the start of the milling at the dosage conventionally used for cement additives. In the example explained here, the cement has a composition corresponding to a cement of the type CEM 1 according to the standard EN 197-1.

Other cement types such as CEM II, CEM III, CEM IV or CEM V can be treated similarly with corresponding results.

Milling tests without additive, with only polycarboxylate ether, with only additive, and with mixtures of polycarboxylate ether and additive in a ratio of 1:1 were carried out according to Table 1, and the milling fineness of the resulting cements was determined. The total active substance content of all the tested aqueous solutions was identical.

TABLE 1

| | | Specific surface area according to Blaine | | |
|---|---|---|---|---|
| | | [cm²/g] (milling fineness) | | |
| | | Aqueous | Aqueous | Aqueous |
| | | solution | solution PCE | solution PCE |
| | | Individual | 1/additive | 2/additive |
| | | additive | (1:1 mixture) | (1:1 mixture) |
| Reference | Without additive | 1920 | | |
| example 1 | | | | |
| Reference | PCE 1 | 2240 | | |
| example 2 | | | | |
| Reference | PCE 2 | 2230 | | |
| example 3 | | | | |
| | Glycols | | | |
| Reference | Monoethylene | 2415 | 2375 | 2385 |
| example 4 | glycol | | | |
| Reference | Tetraethylene | 2505 | 2375 | |
| example 5 | glycol | | | |
| Reference | PEG 200 | 2475 | 2360 | |
| example 6 | | | | |
| Reference | Neopentyl glycol | 2580 | 2460 | |
| example 7 | | | | |
| Reference | Propylene glycol | 2515 | 2415 | |
| example 8 | | | | |
| | Additive | | | |
| Example 1 | Lignin sulfonate | 2130 | 2115 | |
| Example 2 | Glycerol | 2230 | 2280 | |
| Example 3 | Melamine | 2180 | 2175 | |
| | sulfonate | | | |
| Reference | without additive | 1955 | | |
| example 9 | (repetition) | | | |

B. Milling of a Cement with a Three-Component Mixture of PCE/Carboxylic Acid/Alkanolamine

The cement was milled in a closed laboratory ball mill (so-called batch mill). The additives were added to the mill before the milling at the usual dosage for cement additives. In the example presented here, the cement has a composition corresponding to a cement of type CEM II/A-S according to the standard EN 197-1. Other cement types can be treated similarly with corresponding results.

The results are represented in Table 2.

TABLE 2

| | | Specific surface area | Slump |
|---|---|---|---|
| | | according to Blaine | after 5 min |
| | | [cm²/g] | [mm] |
| Reference | without additives | 2369 | — |
| example 10 | | | |
| Reference | Trithanolamine + | 2977 | 198 |
| example 11 | acetic acid | | |
| Example 4 | PCE 2 + | 2955 | 198 |
| | triethanolamine + | | |
| | acetic acid | | |

The slump was not influenced. A corresponding effect can be achieved in general with comb polymers KP.

C. Milling of a Cement with a Three-Component Mixture of PCE/Retarder/Alkanolamine

The cement was milled in a closed laboratory ball mill (so-called batch mill). The additives were added to the mill before the start of the milling at the usual dosage for cement additives. In the example presented here, the cement has a composition corresponding to a cement of type CEM II/B-LL according to the standard EN 197-1. Other cement types can be treated similarly with corresponding results.

The results are represented in Table 3 and they show an improvement of the processability of mortar with the three-component mixture according to the invention.

TABLE 3

| | | | | | | PCE 1 + |
|---|---|---|---|---|---|---|
| | | | without | | PCE 1 + | TEA + |
| | | | additive | PCE 1 | TEA | sodium |
| | | | (reference) | (reference) | (reference) | gluconate |
| Dosage additives | | [%]* | — | 0.2 | 0.2 | 0.2 |
| Slump | 5 min | [mm] | 208 | 225 | 210 | 226 |
| | 30 min | [mm] | 192 | 209 | 196 | 212 |
| | 60 min | [mm] | 191 | 201 | 194 | 205 |

*% by weight, total weight of the additives relative to the cement.

Use of Polycarboxylate Ethers in Combination with Other Additives for Milling Cement

1. A method comprising: applying a cement grinding aid, the cement grinding aid comprising an aqueous composition containing at least one polycarboxylate ether as cement grinding aid, wherein the aqueous composition contains one or more additives or the aqueous composition is used in combination with one or more additives, and wherein the additive is selected from 1,3-propanediol, a carboxylic acid, a sulfonated amino alcohol, boric acid, a salt of boric acid, a salt of phosphoric acid, sorbitol, a saccharide, a gluconate, iron sulfate, tin sulfate, an antimony salt, an alkali salt, an alkaline earth salt, lignin sulfonate, glycerol, melamine, melamine sulfonate and mixtures thereof.

2. The method according to claim 1, wherein the polycarboxylate ether is a comb polymer KP, which comprises or consists of the following partial structural units:
a) a mole fractions of a partial structural unit S1 of formula (I) 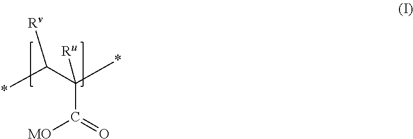
b) b mole fractions of a partial structural unit S2 of formula (II) 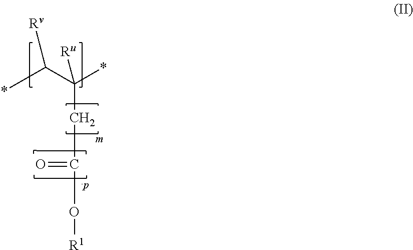
c) c mole fractions of a partial structural unit S3 of formula (III) 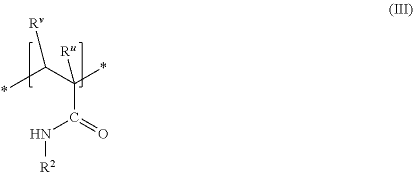
d) d mole fractions of a partial structural unit S4 of formula (IV) 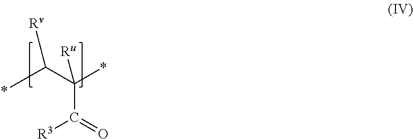
wherein
M independently of one another represents H⁺, an alkali metal ion, alkaline earth metal ion, a bi- or trivalent metal ion, an ammonium ion or an organic ammonium group,
each R^{u} independently of the others stands for hydrogen or a methyl group,
each R^{v} independently of the others stands for hydrogen or COOM,
m=0, 1 or 2,
p=0 or 1,
R¹ and R² independently of one another stand for a C₁ to C₂₀ alkyl group, cycloalkyl group, alkylaryl group or for -[AO]ₙ—R⁴,
wherein A=C₂ to C₄ alkylene, R⁴ stands for H, a C₁ to C₂₀ alkyl group, cyclohexyl group or alkylaryl group,
and n=2-250,
R³ independently of one another stands for NH₂, —NR⁵R⁶, —OR⁷NR⁸R⁹,
wherein R⁵ and R⁶ independently of one another stand for
a C₁ to C₂₀ alkyl group, cycloalkyl group,
alkylaryl group or aryl group,
or for a hydroxyalkyl group or for an
acetoxyethyl (CH₃—CO—O—CH₂—CH₂—) or a
hydroxyisopropyl (HO—CH(CH₃)—CH₂—) or an
acetoxyisopropyl (CH₃—CO—O—CH(CH₃)—CH₂—) group;
or R⁵ and R⁶ together form a ring of which the nitrogen is a part, in order to build a morpholine or imidazoline ring;
R⁷ is a C₂-C₄ alkylene group,
R⁸ and R⁹ each independently of one another represent a C₁ to C₂₀ alkyl group, cycloalkyl group, alkylaryl group, aryl group, or a hydroxyalkyl group,
and wherein a, b, c and d represent mole fractions of the respective partial structural units S1, S2, S3 and S4, where
a/b/c/d=(0.1-0.9)/(0.1-0.9)/(0-0.8)/(0-0.8),
and with the proviso that a+b+c+d=1.

3. The method according to claim 1, wherein the alkali or alkaline earth salt is selected from an alkali or alkaline earth halide, an alkali or alkaline earth nitrate, an alkali or alkaline earth nitrite, and an alkali or alkaline earth thiocyanate, and/or the carboxylic acid is selected from formic acid, acetic acid, propionic acid, lactic acid and citric acid.

4. The method according to claim 1, wherein the aqueous composition contains at least one other grinding aid, or the aqueous composition and the additive(s) are used in combination with at least one other grinding aid,
wherein the additional grinding aid is selected from the group consisting of glycols, polyols, organic amines and ammonium salts of organic amines with carboxylic acids.

5. The method according to claim 4, wherein the organic amine is an amino alcohol.

6. The method according to claim 4, wherein the additive is a carboxylic acid or a retarder selected from boric acid, a salt of boric acid, a salt of phosphoric acid, sorbitol, a saccharide and a gluconate, wherein the carboxylic acid or the retarder is contained in the aqueous composition or used in combination with the aqueous compositions.

7. The method according to claim 2, wherein in the comb polymer KP,
R¹, in each case independently of one another, stands for -[AO]ₙ—R⁴ where n=20-70 and A=C₂ alkylene, wherein R⁴ is defined as above.

8. The method according to claim 2, wherein in the comb polymer KP,
a/b/c/d=(0.3-0.9)/(0.1-0.7)/(0-0.6)/(0-0.4).

9. The method according to claim 1, wherein the proportion of the polycarboxylate ether is 5 to 90% by weight relative to the weight of the aqueous composition.

10. The method according to claim 1, wherein the aqueous composition is a dispersion or a solution.

11. The method of an aqueous composition according to claim 1, wherein the aqueous composition is metered into a clinker or cement, so that the proportion of the polycarboxylate ether is 0.001 to 1.5% by weight relative to the clinker to be milled or to the cement to be milled.

12. A cement grinding aid made of
an aqueous composition containing at least one polycarboxylate ether,
and one or more additives selected from 1,3-propanediol, a carboxylic acid, a sulfonated amino alcohol, boric acid, a salt of boric acid, a salt of phosphoric acid, sorbitol, a saccharide, a gluconate, iron sulfate, tin sulfate, an antimony salt, an alkali salt, an alkaline earth salt, lignin sulfonate, glycerol, melamine, melamine sulfonate and mixtures thereof,
wherein the additive(s) is/are contained in the aqueous composition or the additive(s) is/are a separate component.

13. The cement grinding aid according to claim 12, wherein the polycarboxylate ether is a comb polymer KP, which comprises or consists of the following partial structural units:
a) a mole fractions of a partial structural unit S1 of formula (I) 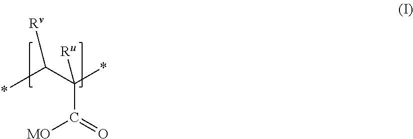
b) b mole fractions of a partial structural unit S2 of formula (II) 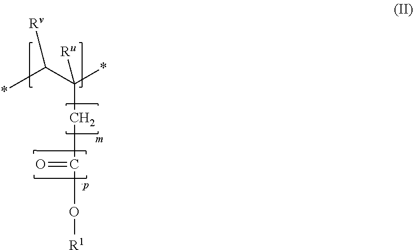
c) c mole fractions of a partial structural unit S3 of formula (III) 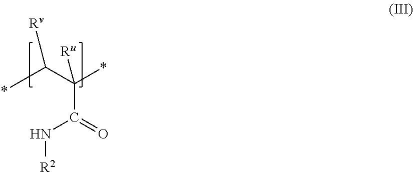
d) d mole fractions of a partial structural unit S4 of formula (IV) 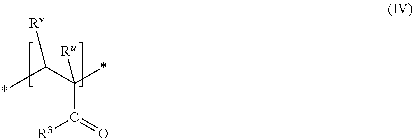
wherein
M independently of one another represents H⁺, an alkali metal ion, alkaline earth metal ion, a bi- or trivalent metal ion, an ammonium ion or an organic ammonium group,
each R^{u} independently of the others stands for hydrogen or a methyl group,
each R^{v} independently of the others stands for hydrogen or COOM,
m=0, 1 or 2,
p=0 or 1,
R¹ and R² independently of one another stand for a C₁ to C₂₀ alkyl group, cycloalkyl group, alkylaryl group or for -[AO]ₙ—R⁴,
wherein A=C₂ to C₄ alkylene, R⁴ stands for H, a C₁ to C₂₀ alkyl group, cyclohexyl group or alkylaryl group,
and n=2-250,
R³ independently of one another stands for NH₂, —NR⁵R⁶, —OR⁷NR⁸R⁹,
wherein R⁵ and R⁶ independently of one another stand for
a C₁ to C₂₀ alkyl group, cycloalkyl group,
alkylaryl group or aryl group,
or for a hydroxyalkyl group or for an
acetoxyethyl (CH₃—CO—O—CH₂—CH₂—) or a
hydroxyisopropyl (HO—CH(CH₃)—CH₂—) or an
acetoxyisopropyl (CH₃—CO—O—CH(CH₃)—CH₂—) group;
or R⁵ and R⁶ together form a ring of which the nitrogen is a part, in order to
build a morpholine or imidazoline ring;
R⁷ is a C₂-C₄ alkylene group, R⁸ and R⁹ each independently of one another represent a C₁ to C₂₀ alkyl group, cycloalkyl group, alkylaryl group, aryl group, or a hydroxyalkyl group,
and wherein a, b, c and d represent mole fractions of the respective partial structural units S1, S2, S3 and S4, where
a/b/c/d=(0.1-0.9)/(0.1-0.9)/(0-0.8)/(0-0.8),
and with the proviso that a+b+c+d=1.

14. A method for producing or milling cement, wherein an aqueous composition comprising at least one polycarboxylate ether and one or more additives is added to a clinker or cement during or before the milling, and the clinker or cement is milled,
and the additive is selected from 1,3-propanediol, a carboxylic acid, a sulfonated amino alcohol, boric acid, a salt of boric acid, a salt of phosphoric acid, sorbitol, a saccharide, a gluconate, iron sulfate, tin sulfate, an antimony salt, an alkali salt, an alkaline earth salt, lignin sulfonate, glycerol, melamine, melamine sulfonate and mixtures thereof,
wherein the additive is contained in the aqueous composition or the aqueous composition and the additive are added separately to the clinker or cement.

15. The method according to claim 14, wherein the polycarboxylate ether is a comb polymer KP, which comprises or consists of the following partial structural units:
a) a mole fractions of a partial structural unit S1 of formula (I) 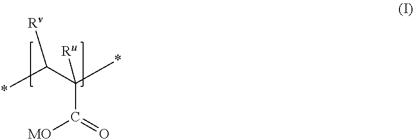
b) b mole fractions of a partial structural unit S2 of formula (II) 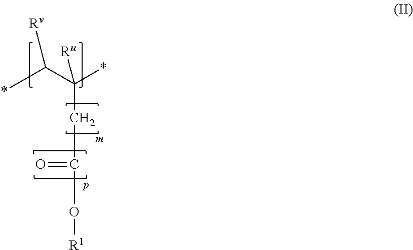
c) c mole fractions of a partial structural unit S3 of formula (III) 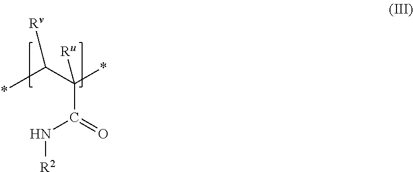
d) d mole fractions of a partial structural unit S4 of formula (IV) 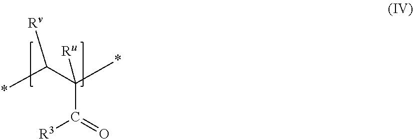
wherein
M independently of one another represents H⁺, an alkali metal ion, alkaline earth metal ion, a bi- or trivalent metal ion, an ammonium ion or an organic ammonium group,
each R^{u} independently of the others stands for hydrogen or a methyl group,
each R^{v} independently of the others stands for hydrogen or COOM,
m=0, 1 or 2,
p=0 or 1,
R¹ and R² independently of one another stand for a C₁ to C₂₀ alkyl group, cycloalkyl group, alkylaryl group or for -[AO]ₙ—R⁴,
wherein A=C₂ to C₄ alkylene, R⁴ stands for H, a C₁ to C₂₀ alkyl group, cyclohexyl group or alkylaryl group,
and n=2-250,
R³ independently of one another stands for NH₂, —NR⁵R⁶, —OR⁷NR⁸R⁹,
wherein R⁵ and R⁶ independently of one another stand for
a C₁ to C₂₀ alkyl group, cycloalkyl group,
alkylaryl group or aryl group,
or for a hydroxyalkyl group or for an
acetoxyethyl (CH₃—CO—O—CH₂—CH₂—) or a
hydroxyisopropyl (HO—CH(CH₃)—CH₂—) or an
acetoxyisopropyl (CH₃—CO—O—CH(CH₃)—CH₂—) group;
or R⁵ and R⁶ together form a ring of which the nitrogen is a part, in order to
build a morpholine or imidazoline ring;
R⁷ is a C₂-C₄ alkylene group,
R⁸ and R⁹ each independently of one another represent a C₁ to C₂₀ alkyl group, cycloalkyl group, alkylaryl group, aryl group, or a hydroxyalkyl group,
and wherein a, b, c and d represent mole fractions of the respective partial structural units S1, S2, S3 and S4, where
a/b/c/d=(0.1-0.9)/(0.1-0.9)/(0-0.8)/(0-0.8)
and with the proviso that a+b+c+d=1.
